(19) United States
(12) Patent Application Publication
(10) Pub. No.: US 2024/0183041 A1
(43) Pub. Date: Jun. 6, 2024

(54) RENEWABLE HYDROGEN PRODUCTION FROM THE PURIFICATION OF RAW METALS

(71) Applicant: MARATHON PETROLEUM COMPANY LP, Findlay, OH (US)

(72) Inventor: Daniel Z. Short, Findlay, OH (US)

(21) Appl. No.: 18/526,316

(22) Filed: Dec. 1, 2023

Related U.S. Application Data
(60) Provisional application No. 63/385,914, filed on Dec. 2, 2022.

(51) Int. Cl. C25B 1/02; C25B 15/02; C25B 15/08; C25C 1/08; C25C 1/12; C25C 7/06

(52) U.S. Cl. CPC C25B 1/02; C25B 15/02; C25B 15/083; C25B 15/085; C25C 1/08; C25C 1/12; C25C 7/06

(57) ABSTRACT

Methods and systems for producing low carbon intensity hydrogen during electrorefining or electrowinning processes to purify raw metals are provided. The method may include causing an electrorefining or electrowinning process in an electrorefining or electrowinning cell so as to deposit a purified metal at a cathode of the cell. The cell may include one or more anodes, one or more cathodes, and an electrolyte or leaching solution comprising the metal to be purified. The cell may also include an electrical source electrically coupled to the one or more anodes and cathodes such that when the electrical source is operated under electrical potential, the purified metal is deposited at the one or more cathodes from the solution and hydrogen gas is generated. The method may further include operating the cell under one or more operating parameters selected to increase hydrogen gas generation during the electrorefining or electrowinning process.

### CROSS REFERENCE TO RELATED APPLICATIONS

This application claims priority to, and the benefit of U.S. Provisional Application No. 63/385,914, filed Dec. 2, 2022, titled “RENEWABLE HYDROGEN PRODUCTION FROM THE PURIFICATION OF RAW METALS,” the disclosure of which is incorporated herein by reference in its entirety.

### TECHNICAL FIELD

The present disclosure generally relates to methods and systems for producing hydrogen during the purification of raw metals. More specifically, the present disclosure relates to, among other embodiments, methods and systems for generating hydrogen gas during an electrodeposition process, such as electrowinning or electrorefining processes.

### BACKGROUND

Electrodeposition processes, such as electrorefining and electrowinning, are important industrial processes for the purification of non-ferrous metals. Both processes result in the electroplating or electrodeposition of purified metal from a solution onto one or more cathodes in a cell. In electrowinning, also called electroextraction, metal ores to be purified are exposed to a leach solution configured to leach the metal to be purified from the metal ore into the leach solution. An electrical current is passed from an inert anode through the leach solution containing the dissolved metal ions so that the metal is recovered and deposited, or electroplated, onto the cathode. Among other metals, copper and nickel are commonly electrowon because these metals have some noble character enabling their soluble cationic forms to be reduced to their pure metallic form at mild applied potentials between the cathode and anode in the cell.

In electrorefining, the anode consists of impure metal to be refined. Electrorefining uses electric potential between the anode and cathode to move a specific metal from the anode to the cathode. An electrolyte solution facilitates the transfer of the metal ions between the anode and the cathode. Typically, the impure metallic anode is oxidized in the acidic electrolyte solution and the metal dissolves into solution. The metal ions migrate through the solution towards the cathode where the pure metal is electroplated or electrodeposited on the cathode. During the electrorefining process, insoluble solid metal impurities may collect and form sediment below the anode. At the end of the electrowinning or electrorefining process, the cathode or cathodes in the cell comprising the purified electrodeposited metal may be harvested or removed from the cell in order to recover the purified metal.

Electrodeposition processes, such as electrorefining and electrowinning, processes are generally conducted under conditions selected to minimize hydrogen production because the evolution of hydrogen gas as a byproduct during operations reduces process efficiency, reduces the quality and purity of the produced metal, and poses a potential hazard. Additionally, operating conditions for electrodeposition processes are generally selected to optimize or maximize metal product quality or purity.

The production of hydrogen gas for use as a clean-burning fuel or as a feedstock for industrial processes is often produced by the electrolysis of water. However, this process tends to be very capital intensive and produces only one product, hydrogen, to justify the costs of production. The applicant has recognized the desirability of additional methods for producing hydrogen, including the desirability of methods that utilize processes that produce multiple products for multiple markets that justify or offset the costs of production.

### SUMMARY

To address these shortcomings, Applicant has developed methods and systems for producing low carbon intensity hydrogen during electrodeposition processes, such as electrorefining or electrowinning processes, to purify raw metals. Embodiments of methods for generating hydrogen during electrodeposition processes are provided. In certain embodiments, the method may include causing an electrodeposition process in an electrodeposition cell so as to deposit a purified metal at a cathode of the cell. The cell may include one or more anodes, one or more cathodes, and an electrolyte or leaching solution comprising the metal to be purified. The solution may be positioned in the cell to be in contact with the one or more anodes and the one or more cathodes. The cell may also include an electrical source electrically coupled to the one or more anodes and cathodes such that when the electrical source is operated under electrical potential, the purified metal is deposited at the one or more cathodes from the solution and hydrogen gas is generated. The method may further include operating the cell under one or more operating parameters selected to increase hydrogen gas generation during the electrorefining or electrowinning process. In certain embodiments, the method may further include obtaining a hydrogen gas stream generated by the cell and removing water from the hydrogen gas stream to generate a purified hydrogen gas stream. The method may further include collecting the hydrogen gas stream from the cell or the purified hydrogen gas stream for use as a fuel or as a reagent in a chemical process.

In certain embodiments, the one or more operating parameters selected to increase hydrogen gas production may be the chemical composition of the solution, the voltage of the cell, the current density (A/m²) of the cell, the voltage difference between the anode and cathode in the cell, the residence time of the solution in the cell, the concentration of metal to be purified in the solution, the concentration of hydrogen-bearing species in the solution, and any combination thereof. In certain embodiments, the solution may include less than or equal to 1 gram (g) dissolved metal to be purified per liter (L) of solution. In certain embodiments, the solution may include less than or equal to 1000 ppm dissolved metal to be purified. In certain embodiments, the cell and/or the electrical source may be operated at a voltage lower than 2 volts (V). In certain embodiments, the solution may include one or more chemical compounds having at least one hydrogen atom. For example, the one or more chemical compounds having at least one hydrogen atom in the solution may be sulfuric acid (H₂SO₄), potassium hydroxide (KOH), sodium hydroxide (NaOH), or any combination thereof.

According to another aspect of the present disclosure, embodiments of systems for generating hydrogen during an electrodeposition process are provided. In certain embodiments, the system may include an electrodeposition cell operable to contain and generate an electrodeposition process therein so as to deposit a purified metal at a cathode of the cell. The cell may include one or more anodes, one or more cathodes, and an electrolyte or leaching solution comprising the metal to be purified. The solution may be positioned in the cell to be in contact with the one or more anodes and the one or more cathodes. The system and/or the cell may also include an electrical source electrically coupled to the one or more anodes and cathodes such that when the electrical source is operated under electrical potential, the purified metal is deposited at the one or more cathodes from the solution and hydrogen gas is generated. The cell and/or the system may be operable to operate under one or more operating parameters selected to increase hydrogen gas generation during the electrodeposition process. The system may also include a hydrogen gas collection unit operable to capture and store hydrogen gas produced by the cell. In certain embodiments, the one or more cathodes may each have an interior cavity configured to receive hydrogen gas generated by the cell and conduct the received hydrogen gas to the hydrogen collection unit or a conduit coupled with the hydrogen collection unit.

In certain embodiments, the hydrogen gas collection unit may include a water absorption unit configured to receive a hydrogen gas stream generated by the cell and remove water from the hydrogen gas stream to produce a purified hydrogen gas stream. The hydrogen gas collection unit may further include a housing defining a receiving space operate to receive and store the purified hydrogen gas stream. In some embodiments, the hydrogen gas collection unit may further include a compressor operable to compress the purified hydrogen gas received in the receiving space so as to increase the amount of purified hydrogen gas able to be stored therein.

In certain embodiments, the system may also include a control system coupled with the cell and electrical source. The control system may be operable to control the one or more operating parameters so as to control the amount of hydrogen gas produced during the electrodeposition process. For example, the one or more operating parameters selected to increase hydrogen gas production may include the chemical composition of the solution, the voltage of the cell, the current density (A/m²) of the cell, the voltage difference between the anode and cathode in the cell, the residence time of the solution in the cell, the concentration of metal to be purified in the solution, the concentration of hydrogen-bearing species in the solution, and any combination thereof. In certain embodiments, the control system may be configured to control the composition of the solution such that it comprises less than or equal to 1 gram (g) dissolved metal to be purified per liter (L) of solution. In certain embodiments, the control system may be configured to control the composition of the solution such that it comprises less than or equal to 1000 ppm dissolved metal to be purified. In certain embodiments, the control system may be configured to operate the cell and/or the electrical source at a voltage lower than 2 volts (V).

Still other aspects and advantages of these exemplary embodiments and other embodiments, are discussed in detail herein. Moreover, it is to be understood that both the foregoing information and the following detailed description provide merely illustrative examples of various aspects and embodiments and are intended to provide an overview or framework for understanding the nature and character of the claimed aspects and embodiments. Accordingly, these and other advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than may be necessary for a fundamental understanding of the embodiments discussed herein and the various ways in which they may be practiced. According to common practice, the various features of the drawings discussed below are not necessarily drawn to scale. Dimensions of various features and elements in the drawings may be expanded or reduced to more clearly illustrate embodiments of the disclosure.

FIG. 1 is a graphical representation of a system and process for generating hydrogen during an electrowinning process, according to an exemplary embodiment of the present disclosure.

FIG. 2 is a graphical representation of a system and process for generating hydrogen during an electrorefining process, according to an exemplary embodiment of the present disclosure.

FIG. 3 is a graphical representation of a control system for controlling the generation of hydrogen in a cell during an electrowinning process, according to an exemplary embodiment of the present disclosure.

FIG. 4 is a graphical representation of a control system for controlling the generation of hydrogen in a cell during an electrorefining process, according to an exemplary embodiment of the present disclosure.

FIG. 5 is a flow diagram that may be implemented by a control system, such as the control system shown in FIG. 3 or FIG. 4, of a method and system for controlling the hydrogen gas production rate in a cell during an electrodeposition process, according to an exemplary embodiment of the present disclosure.

FIG. 6 is a flow diagram that may be implemented by a control system, such as the control system shown in FIG. 3 or FIG. 4, of a method and system for controlling the dissolved metal concentration in a cell during an electrodeposition process, according to an exemplary embodiment of the present disclosure.

FIG. 7 is a flow diagram that may be implemented by a control system, such as the control system shown in FIG. 3 or FIG. 4, of a method and system for controlling the pH or the hydrogen-bearing species concentration in a cell during an electrodeposition process, according to an exemplary embodiment of the present disclosure.

### DETAILED DESCRIPTION

The present disclosure describes various embodiments related to methods and systems for producing hydrogen during the purification of raw metals. In particular, the present disclosure relates to, among other embodiments, methods and systems for generating hydrogen gas during electrodeposition processes, such as electrowinning or electrorefining processes. Further embodiments may be described and disclosed.

In the following description, numerous details are set forth in order to provide a thorough understanding of the various embodiments. In other instances, well-known processes, devices, and systems may not have been described in particular detail in order not to unnecessarily obscure the various embodiments. Additionally, illustrations of the various embodiments may omit certain features or details in order to not obscure the various embodiments.

The description may use the phrases “in some embodiments,” “in various embodiments,” “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “reducing,” “reduced,” or any variation thereof, when used in the claims and/or the specification includes any measurable decrease or complete inhibition to achieve a desired result.

The use of the words “a” or “an” when used in conjunction with any of the terms “comprising,” “including,” “containing,” or “having,” in the claims or the specification may mean “one,” but it is also consistent with the meaning of “one or more,” “at least one,” and “one or more than one.” The terms “wt. %”, “vol. %”, or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

Disclosed herein are methods and systems for generating hydrogen during the electroplating of purified metal at a cathode during a metal purification process. In at least some embodiments, the metal purification process may be an electrorefining process or an electrowinning process. It has been unexpectedly found that under certain operating conditions, metal purification cells may be operated to produce economic quantities of hydrogen gas while still preparing metals with high enough purity to have value. In certain embodiments, it has been found that metal purification cells may be operated at suboptimal conditions for purifying the metal but under conditions in which the decreased value of the suboptimally pure metal is offset by the value of the low carbon intensity hydrogen gas collected from the cell.

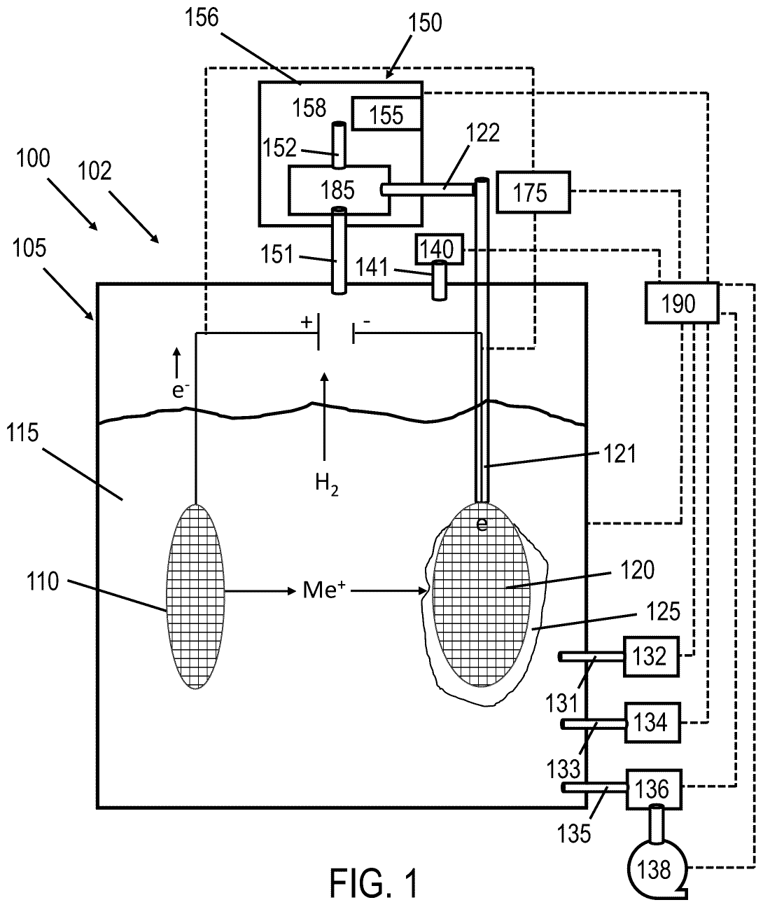

In at least some embodiments, methods and systems for generating hydrogen during an electrodeposition process, such as an electrowinning process, are provided. A graphical representation of a system 100 and electrowinning process 102 for generating hydrogen during the electrowinning process 102 is provided in FIG. 1, according to an exemplary embodiment of the present disclosure. The electrowinning process 102 may include exposing one or more metal ores, comprising the metal to be purified, to a leach solution 115 configured to cause the metal to be purified to leach from the metal ore into the leach solution 115. The metal purified by electrowinning may be any non-ferrous metal and the metal ore used in the electrowinning process 102 may be any non-ferrous ore. In at least some instances, the metal ore may be a metal ore of copper, nickel, cobalt, or any combination thereof. In other instances, the metal ore may be a metal ore of lead, copper, gold, silver, zinc, aluminum, chromium, cobalt, manganese, or any combination thereof. In still other instances, the metal ore may be a metal ore of a rare earth metal or an alkali metal, or a combination of rare earth metals or alkali metals. For example, the metal ore may, in some instances, be an ore of neodymium, lanthanum, yttrium, dysprosium, cerium, terbium, praseodymium, europium, scandium, samarium, gadolinium, lutetium, holmium, thulium, ytterbium, erbium, promethium, or any combination thereof. In other cases, the metal ore may, in some instances, be an ore of sodium, potassium, cesium, rubidium, lithium, francium, or any combination thereof. In at least some instances, the leach solution 115 may be an aqueous solution that comprises sulfuric acid (H₂SO₄), potassium hydroxide (KOH), or sodium hydroxide (NaOH). In at least some embodiments, the leach solution 115 may have a pH that is less than 3 or a pH that is greater than 10.

The electrowinning process 102 may further include positioning the leach solution 115, comprising the dissolved metal leached from the metal ore, in an electrowinning cell 105 such that the leach solution 115 is in contact with one or more anodes 110 and one or more cathodes 120 in the cell 105. The one or more anodes 110 and cathodes 120 in the cell may be electrically coupled with an electrical source 175 configured to cause an electrowinning process 102 in the cell 105. The cell 105 may be configured to operate such that when the electrical source 175 is operated under electrical potential the purified metal is deposited or plated 125 at the one or more cathodes 120 from the leaching solution 115 and hydrogen gas is generated. Accordingly, the electrowinning process 102 may also include passing an electrical current from an inert anode 110 through the leach solution 115 containing the dissolved metal ions so that the metal is recovered and deposited 125, or electroplated, onto the cathode 120. In certain embodiments, hydrogen gas is generated during the electrowinning process 102 as a result of electrolysis of water in the aqueous leach solution 115. In certain embodiments, hydrogen gas is liberated from one or more hydrogen containing compounds other than water in the leach solution 115 as a result of conducting the electrowinning process 102. Accordingly, the presently disclosed electrowinning process 102 may further include collecting the hydrogen gas (H₂) from the cell for use as a fuel or as a reagent in a chemical process.

As depicted in FIG. 1, hydrogen gas collection unit 150 may be coupled to cell 105 via conduit 151 and operable to receive, collect, and store hydrogen gas generated in cell 105 during electrowinning process 102. In particular, conduit 151 may be capable of conducting or providing a means of transit of hydrogen gas collected in the headspace of cell 105 (gaseous volume above the leach solution 115) to the hydrogen gas collection unit 150. Hydrogen gas collection unit 150 may be any device or apparatus capable or receiving and storing hydrogen gas generated in cell 105. In some instances, the cathode 120 may be a hollow cathode or otherwise include an interior cavity 121 configured to receive hydrogen gas generated within the cell, particularly proximal to the cathode itself, as a result of the electrowinning process 102. In such instances, the interior cavity 121 of cathode 120 may be configured to conduct the received hydrogen gas generated at the cathode 120 to the hydrogen collection unit 150 or a conduit coupled with the hydrogen collection unit, such as conduit 122.

Hydrogen gas collection unit 150 may include a water absorption unit 185 configured to receive a hydrogen gas stream generated by the cell and remove water from the hydrogen gas stream to produce a purified hydrogen gas stream. As shown in FIG. 1, water absorption unit 185 may receive a hydrogen gas stream from the interior cavity 121 of cathode 120, for example via conduit 122, and/or from the headspace within cell 105, for example via conduit 151. The water absorption unit 185 may be operable to remove water from the hydrogen gas stream to produce a purified hydrogen gas stream, which may be expelled into an interior receiving space 158 within the hydrogen gas collection unit 150. For example, as depicted in FIG. 1, the purified hydrogen gas stream is expelled into interior receiving space 158 via conduit 152. The interior receiving space 158 may be defined by a housing 156 of the hydrogen gas collection unit 150. The receiving space 158 of housing 156 may be configured to receive and store the purified hydrogen gas stream generated by the water absorption unit 185. As shown in FIG. 1, hydrogen gas collection unit 150 may further include a compressor operable to compress the purified hydrogen gas received in the receiving space 158 so as to increase the amount of purified hydrogen gas able to be stored in the receiving space 158 and hydrogen gas collection unit 150.

In certain embodiments, the electrowinning cell 105 may be operated under one or more operating parameters selected to increase hydrogen gas generation during the electrowinning process 102. For example, the one or more operating parameters that may be selected to increase hydrogen gas production may include the chemical composition of the leach solution 115, the voltage of the cell 105 applied by electrical source 175, the current density (A/m²) of the cell 105 applied by electrical source 175, the voltage difference between the anode 110 and cathode 120 in the cell 105 applied by electrical source 175, the residence time of the leach solution 115 in the cell 105, the concentration of metal to be purified in the leach solution 115, the concentration of hydrogen-bearing species in the leach solution 115, and any combination thereof. In certain embodiments, the leach solution 115 may have less than or equal to 1 gram (g) dissolved metal to be purified per liter (L) of leach solution 115 or contain less than or equal to 1000 ppm dissolved metal to be purified, as it has been found that in certain exemplary embodiments this operating parameter facilitates hydrogen production during the electrowinning process 102.

In certain embodiments, the leach solution 115 may have less than or equal to 1 gram (g) dissolved copper to be purified per liter (L) of leach solution 115 or contain less than or equal to 1000 ppm dissolved copper to be purified, as it has been found that in certain exemplary embodiments this operating parameter facilitates hydrogen production during the electrowinning process 102. In certain embodiments, the leach solution 115 may comprise one or more chemical compounds that have at least one hydrogen atom. Such leach solutions 115 may be selected to increase hydrogen production during the electrowinning process 102. For example, the leach solution 115 used in the electrowinning process 102 may include sulfuric acid (H₂SO₄), potassium hydroxide (KOH), sodium hydroxide (NaOH), and combinations thereof. However, other hydrogen-bearing chemical species may also be used in the leach solution 115. In certain embodiments, the leach solution 115 may be a copper sulfate-sulfuric acid (CuSO₄—H₂SO₄) leach solution 115. In certain embodiments, the leach solution 115 may be a nickel chloride leach solution 115.

In certain embodiments, it has been found that the pH of the leach solution 115 may affect hydrogen generation during the electrowinning process 102. In particular, in certain embodiments, the leach solution 115 may have a pH less than 3. In certain embodiments, the cell 105 may be operated such that the pH of the leach solution 115 proximal to the cathode is less than 3. In certain embodiments, the leach solution 115 does not include a buffer added to adjust, modify, or control the pH of the leach solution 115. In certain embodiments, the leach solution 115 specifically excludes a buffer added to adjust, modify, or control the pH of the leach solution 115. In certain embodiments, the leach solution 115 does not include boric acid or specifically excludes boric acid.

In certain embodiments, the leach solution 115 may include one or more chemical components capable of facilitating the liberation of hydrogen gas from the leach solution 115 itself or surfaces in the cell 105 that are in contact with the leach solution 115, such as the surface of the cathode 120, which may collect hydrogen gas bubbles during the electrowinning process 102. For example, in some embodiments, the leach solution may include sodium lauryl sulfate.

In certain embodiments, the cell 105 and/or the electrical source 175 is operated at a voltage lower than 2 volts (V), as it has been found that in certain exemplary embodiments this operating parameter facilitates hydrogen production during the electrowinning process 102. In certain embodiments, the anode 110 used in the electrowinning cell 105 may comprise lead (Pb) or an alloy thereof. In certain embodiments, the cathode 120 in the electrowinning cell may comprise stainless steel, aluminum (Al), titanium (Ti), or alloys thereof. In certain embodiments of the electrowinning process 102, the purified metal 125 deposited or electroplated at the cathode 120 may be characterized by a purity of less than 99%, or less than 98%, or less than 97%, or less than 95%.

The present disclosure also provides an electrowinning system 100 for generating hydrogen during an electrowinning process 102. The electrowinning system 100 may include an electrowinning cell 105 that includes one or more anodes 110 and one or more cathodes 120 and that is operable to contain and generate an electrowinning process 102 therein so as to deposit a purified metal 125 at one or more cathodes 120 in the electrowinning cell 105. The electrowinning system 100 may also include a leach solution 115 comprising the metal to be purified positioned in the electrowinning cell 105 to be in contact with the one or more anodes 110 and the one or more cathodes 120. The electrowinning system 100 may also include an electrical source 175 electrically coupled to the one or more anodes 110 and cathodes 120 such that when the electrical source 175 is operated under electrical potential, the purified metal 125 is deposited at the one or more cathodes 120 from the leach solution 115 and hydrogen gas is generated. The electrowinning system 100 may also include a hydrogen gas collection unit 150 operable to capture and store hydrogen gas produced by the electrowinning cell 105. The electrowinning cell 105 in the system is operable to operate under one or more operating parameters selected to increase hydrogen gas generation during the electrowinning process 102, as described above.

In certain embodiments, the electrowinning system 100 may further include a control system 190 coupled with the cell 105 and electrical source 175. The control system 190 may be operable to control the one or more operating parameters of the cell 105 and/or the electrical source 175 so as to control or affect the amount of hydrogen gas produced during the electrowinning process 102. For example, the control system 190 may be configured to control the chemical composition of the leach solution 115, the voltage of the cell 105, the current density (A/m²) of the cell 105, the voltage difference between the anode 110 and cathode 120 in the cell 105, the residence time of the leach solution 115 in the cell 105, the concentration of metal to be purified in the leach solution 115, the concentration of hydrogen-bearing species in the leach solution 115, and any combination thereof. In certain embodiments, the control system 190 may be configured to control the composition of the leach solution 115 such that it comprises less than or equal to 1 gram (g) dissolved metal to be purified per liter (L) of leach solution 115. In certain embodiments, the control system 190 may be configured to control the composition of the leach solution 115 such that it comprises less than or equal to 1000 ppm dissolved metal to be purified. In certain embodiments, the control system 190 may be configured to operate the cell 105 and/or the electrical source 175 at a voltage lower than 2 volts (V).

According to certain aspects of the present disclosure, electrowinning system 100 may include a hydrogen sensor 140 operable to measure the amount of hydrogen gas evolving from or being produced by cell 105. In at least some instances, hydrogen sensor 140 may be operable to measure the concentration of hydrogen gas collected in the headspace or gas-filled volume of the cell 105 above the leach solution 115. Hydrogen sensor 140 may comprise any equipment capable of ascertaining or measuring hydrogen gas production by cell 105, whether the measurement be a quantitative or qualitative determination of hydrogen gas quantity or concentration.

The hydrogen sensor 140 may be located within cell 105 or external to cell 105. For example, in some instances, the hydrogen sensor 140 may be positioned within cell 105, either in the headspace or gaseous volume above the leach solution 115 or within the leach solution 115 itself. In other instances, the hydrogen sensor 140 may be positioned outside or external to the cell 105. For example, as shown in FIG. 1, hydrogen sensor 140 may be located external to cell 105 and coupled to the cell 105 by a conduit 141 operable to receive gas from the cell 105. For example, as shown in FIG. 1, at least some embodiments may include hydrogen sensor 140 coupled with a conduit 141 in fluid communication with the headspace or gaseous volume above the leach solution 115. For example, hydrogen sensor 140 may be coupled with conduit 141 connecting the hydrogen sensor 140 to cell 105, particularly the headspace above the leach solution 115 where the hydrogen gas may collect after evolving from leach solution 115. In other instances, hydrogen sensor 140 may be coupled to the cell 105 via conduit 141 such that the hydrogen sensor 140 may be in fluid communication with the leach solution 115 or aliquots removed therefrom. In at least some instances, the hydrogen sensor 140 may be operable to measure the concentration or amount of hydrogen gas entering hydrogen gas collection unit 150. In such instances, the hydrogen sensor 140 may be coupled with a conduit 151 connecting the hydrogen gas collection unit 150 to cell 105.

Hydrogen sensor 140 may be in communication with or otherwise electronically coupled to control system 190. In particular, control system 190 may be operable to receive hydrogen gas measurements from hydrogen gas sensor 140 and thus monitor the amount of hydrogen gas generated or produced by cell 105 and/or collected by hydrogen gas collection unit 150. In at least some instances, hydrogen gas collection unit 150, or a component thereof, may be electronically coupled with control system 190. Control system 190 may be configured to adjust one or more operating parameters of the cell 105 and/or the electrical source 175 based on the measurement(s) received from the hydrogen sensor 140. In at least some instances, the control system 190 may be configured or otherwise operable to increase or decrease the hydrogen generation of the cell 105 by adjusting one or more operating parameters of the cell 105 in response to hydrogen gas measurements received by the control system 190 from the hydrogen sensor 140. In at least some instances, the hydrogen sensor 140, and measurements provided therefrom, as well as the control system 190 configured to adjust one or more operating parameters of the cell 105 based on the hydrogen measurements received from the hydrogen sensor 140, form or create a feedback loop responsive to hydrogen gas generation by the cell 105.

In at least some instances, the control system 190 may be configured to maintain the hydrogen gas production rate of the cell 105 within a predetermined range of desirable and safe hydrogen gas production rates. Similarly, control system 190 may be configured to maintain the amount or concentration of hydrogen gas in one or more portions of system 100 or cell 105 within a predetermined amount or concentration, or predetermined range of amounts or concentrations, by adjusting one or more operating parameters of the cell 105 based on feedback from the hydrogen sensor 140. The one or more operating parameters of the cell 105 that may be adjusted by control system 190 based on feedback measurements obtained from hydrogen sensor 140, may include, for example, the chemical composition of the leach solution 115, the voltage of the cell 105, the current density (A/m²) of the cell 105, the voltage difference between the anode 110 and cathode 120 in the cell 105, the residence time of the leach solution 115 in the cell 105, the concentration of metal to be purified in the leach solution 115, the concentration of hydrogen-bearing species in the leach solution 115, and any combination thereof. Control system 190 may adjust or control the voltage of the cell 105, the current density (A/m²) of the cell 105, and the voltage difference between the anode 110 and cathode 120 in the cell 105 by operating or controlling electrical source 175, which is electronically coupled with control system 190.

Control system 190 may adjust or control the chemical composition of the leach solution 115, the residence time of the leach solution 115 in the cell 105, the concentration of metal to be purified in the leach solution 115, and the concentration of hydrogen-bearing species in the leach solution 115 by operating or controlling solution chemistry adjuster apparatus 136 and/or pump 138. As shown in FIG. 1, solution chemistry adjuster apparatus 136 may be coupled with cell 105 via conduit 135 which is configured to allow the passage of new leach solution 115, additional solution components, and/or the removal of spent leach solution 115 from cell 105. As shown in FIG. 1, pump 138 may be fluidly coupled with solution chemistry adjuster apparatus 136 and cell 105 via conduit 135. In at least some instances, solution chemistry adjuster apparatus 136 may be operable to add additional hydrogen-bearing species or other chemical components to the leach solution 115, or alter the residence time of the leach solution 115 in cell 105 by flowing additional leach solution 115 into the cell 105 or removing spent leach solution 115 from the cell 105.

Control system 190 may also be communicatively coupled with one or more pH sensors 132 as well as other solution chemistry sensors 134 operable to measure the pH of the leach solution 115 or other chemical parameters and communicate such measurements to the control system 190. The control system 190 may operate the solution chemistry adjuster apparatus 136 based on feedback and measurements provided by pH sensor 132 and/or solution chemistry sensor 134. pH sensor 132 may be positioned in contact with leach solution 115, either within cell 105 or exterior to cell 105. When pH sensor 132 is positioned outside of cell 105, the pH sensor 132 may be in fluid communication with the leach solution 115 via conduit 131. Similarly, solution chemistry sensor 134 may be positioned in contact with leach solution 115, either within cell 105 or exterior to cell 105. When the solution chemistry sensor 134 is positioned outside of cell 105, the solution chemistry sensor 134 may be in fluid communication with the leach solution 115 via conduit 133.

In at least some instances, control system 190 may be configured to maintain the pH of the leach solution 115 within a predetermined range by controlling or operating the solution chemistry adjuster apparatus 136 to introduce chemical components to adjust the pH of the leach solution 115 in order to obtain or maintain the pH of the leach solution 115 within the predetermined range. In at least some instances, the predetermined range of pH is between about 10 and 11.

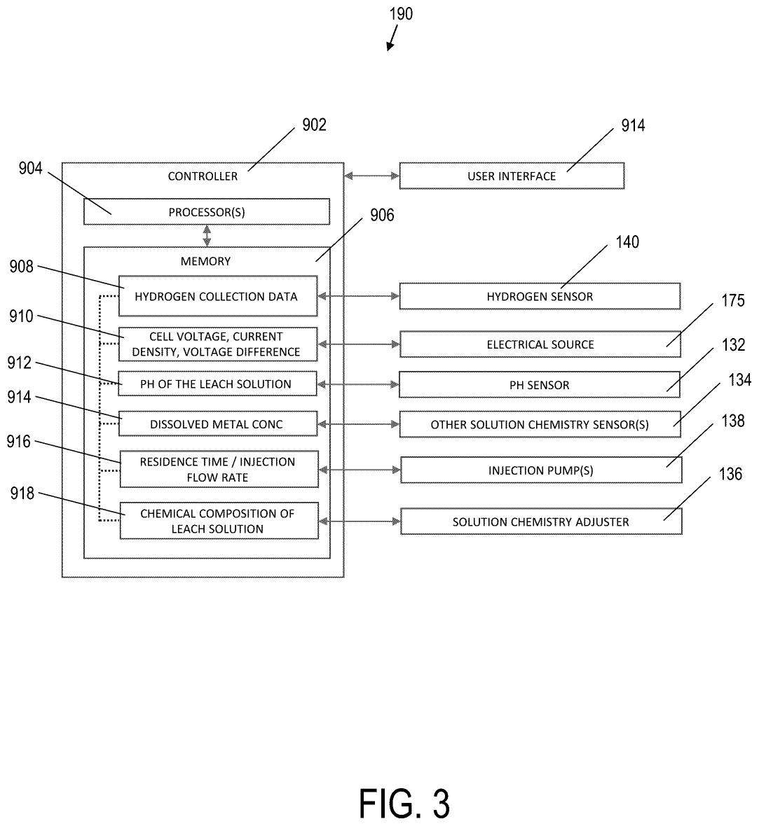

FIG. 3 depicts a graphical representation of a control system 190 for controlling the generation of hydrogen in a cell during an electrodeposition process, in particular an electrowinning process, according to an exemplary embodiment of the present disclosure. Other embodiments of control systems 190 are within the spirit and scope of the present disclosure. As depicted in FIG. 3, control system 190 may include a controller 902. Controller 902 may comprise one or more controllers, a programmable logic controller (PLC), a supervisory control and data acquisition (SCADA) system, a computing device, and combinations thereof, as well as other components, to manage or control the generation of hydrogen in cell 105, particularly to control the generation of hydrogen gas in cell 105 such that hydrogen gas is generated at a production rate that is within a predetermined range determined to be safe and economically advantageous. Controller 902 may include one or more processors (e.g., processor 904) to execute instructions stored in memory 906. In an exemplary embodiment, the memory 906 may be a machine-readable storage medium. As used herein, a “machine-readable storage medium” may be any electronic, magnetic, optical, or other physical storage apparatus to contain or store information such as executable instructions, data, and the like. For example, any machine-readable storage medium describe herein may be any of random access memory (RAM), volatile memory, non-volatile memory, flash memory, a storage drive (e.g., hard drive), a solid state drive, any type of storage disc, and the like, or a combination thereof. As noted, the memory 906 may store or include instructions executable by processor 904. As used herein, a “processor” may include, for example one processor or multiple processors included in a single device or distributed across multiple computing devices. The processor 904 may be at least one of a central processing unit (CPU), a semiconductor-based microprocessor, a graphics processing unit (GPU), a field-programmable gate array (FPGA) to retrieve and execute instructions, a real time processor (RTP), other electronic circuitry suitable for the retrieval and execution of instructions stored on a machine-readable storage medium, or a combination thereof.

Instructions stored in the memory 906 and executable by the processor 904 may include instructions 910 to determine, control, or adjust the cell voltage, current density, or voltage difference in the cell by controlling electrical source 175. Controller 902 may control the electrical source 175 in order to adjust the cell voltage, current density, or voltage difference between the cathode 120 and electrode 110 in the cell 105. Controller 902 may also include instructions 908 for determining hydrogen collection data, particularly the hydrogen gas generation rate of the cell, using hydrogen sensor 140. Controller 902 may also include instructions 912 for determining the pH of the leach solution by operating pH sensor 132. Similarly, controller 902 may include instructions 914 for determining the dissolved metal concentration in the leach solution through operation of solution chemistry sensor(s) 134. Controller 902 may further include instructions 916 for controlling the residence time and injection flow rate of the leach solution in the cell as well as instructions 918 for controlling the chemical composition of the leach solution by operating injection pump(s) 138 and solution chemistry adjuster 136. Instructions or data may also be received from user interface 914 and generally stored in memory 906.

In certain embodiments, the presently disclosed electrowinning system 100 and/or the electrowinning cell 105 does not include a hydrogen generation mitigation apparatus that may be otherwise included in an electrowinning system for the mitigation of risks or product quality resulting from the evolution of hydrogen gas during the electrowinning process. For example, the presently disclosed electrowinning system 100 and/or electrowinning cell 105 may, in certain embodiments, exclude one or more of separate anode and cathode compartments, a barrier separating the anode and the cathode, a diaphragm positioned between the anode and the cathode, an anode bag disposed about the anode, and a cathode bag disposed about the cathode.

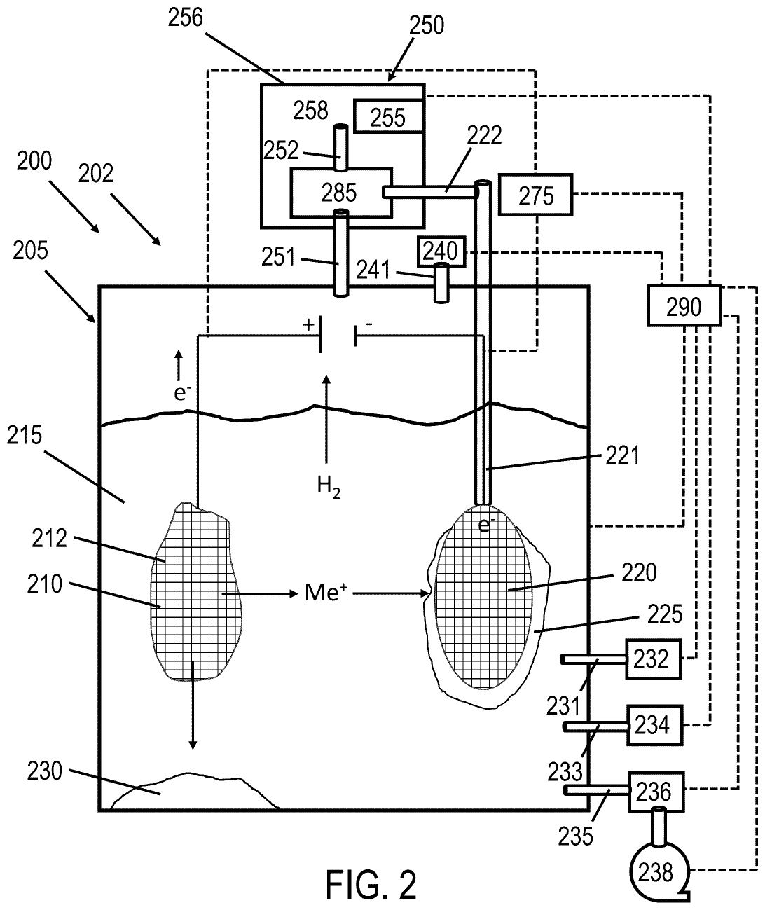

According to another aspect of the present disclosure, the presently disclosed metal purification process may be an electrodeposition process, in particular an electrorefining process 202 as depicted in FIG. 2. It has been unexpectedly found that under certain operating conditions, electrorefining cells may be operated to produce economic quantities of hydrogen gas while still preparing metals with high enough purity to have value. In certain embodiments, it has been found that electrorefining cells may be operated at suboptimal conditions for purifying the metal but under conditions in which the decreased value of the suboptimally pure metal is offset by the value of the low carbon intensity hydrogen gas collected from the cell.

In at least some embodiments, methods and systems for generating hydrogen during an electrodeposition process, in particular an electrorefining process 202 are provided. A graphical representation of a system 200 and process 202 for generating hydrogen during an electrorefining process is provided in FIG. 2, according to an exemplary embodiment of the present disclosure. As depicted in FIG. 2, the electrorefining process 202 may include providing one or more metal ores 212 comprising the metal to be purified and positioning the one or more metal ores 212 at an anode 210 of an electrorefining cell 205. In certain embodiments, the metal ore 212 to be purified serves or is otherwise used as the anode 210 in the electrorefining cell 205. In at least certain embodiments, the anode 210 in the electrorefining cell 205 is formed from the metal ore 212.

The metal purified by electrorefining may be any non-ferrous metal and the metal ore 212 used in the electrorefining process may be any non-ferrous ore. In at least some instances, the metal ore 212 may be a metal ore of copper, nickel, cobalt, silver, platinum, gold, ruthenium, rhodium, palladium, osmium, iridium, or any combination thereof. The presently disclosed electrorefining method 202 may further include contacting the metal ore 212 or anode 210 with an electrolyte solution 215 in contact with the cathode 210 in the electrorefining cell 205. In at least some instances, the electrolyte solution 215 may be an aqueous solution that comprises sulfuric acid (H₂SO₄), potassium hydroxide (KOH), or sodium hydroxide (NaOH). In at least some embodiments, the electrolyte solution 215 may have a pH that is less than 3 or a pH that is greater than 10.

The electrorefining process 202 may further include positioning the electrolyte solution 215 in an electrorefining cell 205 such that the electrolyte solution 215 is in contact with one or more anodes 210 and one or more cathodes 220 in the cell 205. The one or more anodes 210 and cathodes 220 in the cell 205 may be electrically coupled with an electrical source 275 configured to cause an electrorefining process 202 in the cell 205. The electrorefining cell 205 may be configured to operate such that when the electrical source 275 is operated under electrical potential metal ions originating from the impure metal ore 212 anode 210 migrate through the electrolyte solution 215 and are deposited or plated 225 at the one or more cathodes 220 as purified metal 225. Accordingly, the electrorefining process 202 may also include passing an electrical current from an impure metal ore 212 anode 210 through the electrolyte solution 215 containing dissolved metal ions originating from the anode 210 so that the metal is recovered and deposited 225, or electroplated, onto the cathode 220. During the electrorefining process 202, hydrogen gas is generated either as a result of electrolysis of water molecules in the aqueous electrolyte solution 215 or as a result of disassociation of hydrogen containing compounds in the electrolyte solution 215. The presently disclosed electrorefining process 202 may further include collecting the hydrogen gas (H₂) from the electrorefining cell 205 for use as a fuel or as a reagent in a chemical process. As depicted in FIG. 2, hydrogen gas collection unit 250 may be coupled to cell 205 and operable to receive, collect, and store hydrogen gas generated in cell 205 during electrorefining process 202. In particular, conduit 251 may be capable of conducting or providing a means of transit of hydrogen gas collected in the headspace of cell 205 (gaseous volume above the leach solution 215) to the hydrogen gas collection unit 250. Hydrogen gas collection unit 250 may be any device or apparatus capable of receiving and storing hydrogen gas generated in cell 205. In some instances, the cathode 220 may be a hollow cathode or otherwise include an interior cavity 221 configured to receive hydrogen gas generated within the cell, particularly proximal to the cathode itself, as a result of the electrorefining process 202. In such instances, the interior cavity 221 of cathode 220 may be configured to conduct the received hydrogen gas generated at the cathode 220 to the hydrogen collection unit 250 or a conduit coupled with the hydrogen collection unit, such as conduit 222.

Hydrogen gas collection unit 250 may include a water absorption unit 285 configured to receive a hydrogen gas stream generated by the cell and remove water from the hydrogen gas stream to produce a purified hydrogen gas stream. As shown in FIG. 2, water absorption unit 285 may receive a hydrogen gas stream from the interior cavity 221 of cathode 220, for example via conduit 222, and/or from the headspace within cell 205, for example via conduit 251. The water absorption unit 285 may be operable to remove water from the hydrogen gas stream to produce a purified hydrogen gas stream, which may be expelled into an interior receiving space 258 within the hydrogen gas collection unit 250. For example, as depicted in FIG. 2, the purified hydrogen gas stream is expelled into interior receiving space 258 via conduit 252. The interior receiving space 258 may be defined by a housing 256 of the hydrogen gas collection unit 250. The receiving space 258 of housing 256 may be configured to receive and store the purified hydrogen gas stream generated by the water absorption unit 285. As shown in FIG. 2, hydrogen gas collection unit 250 may further include a compressor operable to compress the purified hydrogen gas received in the receiving space 258 so as to increase the amount of purified hydrogen gas able to be stored in the receiving space 258 and hydrogen gas collection unit 250.

In certain embodiments, the electrorefining cell 205 may be operated under one or more operating parameters selected to increase hydrogen gas generation during the electrorefining process 202. For example, the one or more operating parameters that may be selected to increase hydrogen gas production may include the chemical composition of the electrolyte solution 215, the voltage of the cell 205 applied by the electrical source 275, the current density (A/m²) of the cell 205 applied by the electrical source 275, the voltage difference between the anode 210 and cathode 220 in the cell 205 applied by the electrical source 275, the residence time of the electrolyte solution 215 in the cell 205, the concentration of metal to be purified in the electrolyte solution 215, the concentration of hydrogen-bearing species in the electrolyte solution 215, and any combination thereof. In certain embodiments, the electrolyte solution 215 may have less than or equal to 1 gram (g) dissolved metal to be purified per liter (L) of solution 215 or contain less than or equal to 1000 ppm dissolved metal to be purified, as it has been found that in certain exemplary embodiments this operating parameter facilitates hydrogen production during the electrorefining process 202.

In certain embodiments, the electrolyte solution 215 may have less than or equal to 1 gram (g) dissolved copper to be purified per liter (L) of solution 215 or contain less than or equal to 1000 ppm dissolved copper to be purified, as it has been found that in certain exemplary embodiments this operating parameter facilitates hydrogen production during the electrorefining process 202. In certain embodiments, the electrolyte solution 215 may comprise one or more chemical compounds that have at least one hydrogen atom. Such electrolyte solutions 215 may be selected to increase hydrogen production during the electrorefining process 202. For example, the electrolyte solution 215 used in the electrorefining process 202 may include sulfuric acid (H₂SO₄), potassium hydroxide (KOH), sodium hydroxide (NaOH), and combinations thereof. However, other hydrogen-bearing chemical species may also be used in the electrolyte solution 215. In certain embodiments, the electrolyte solution 215 may be a copper sulfate-sulfuric acid (CuSO₄—H₂SO₄) electrolyte solution. In certain embodiments, the electrolyte solution 215 may be a nickel chloride electrolyte solution.

In certain embodiments, it has been found that the pH of the electrolyte solution 215 may affect hydrogen generation during the electrorefining process 202. In particular, in certain embodiments, the electrolyte solution 215 may have a pH less than 3. In certain embodiments, the cell 205 may be operated such that the pH of the electrolyte solution 215 proximal to the cathode 220 is less than 3. In certain embodiments, the electrolyte solution 215 does not include a buffer added to adjust, modify, or control the pH of the solution 215. In certain embodiments, the electrolyte solution 215 specifically excludes a buffer added to adjust, modify, or control the pH of the solution. In certain embodiments, the electrolyte solution 215 does not include boric acid or specifically excludes boric acid.

In certain embodiments, the electrolyte solution 215 may include one or more chemical components capable of facilitating the liberation of hydrogen gas from the electrolyte solution 215 itself or surfaces in the cell 205 that are in contact with the electrolyte solution 215, such as the surface of the cathode 220, which may collect hydrogen gas bubbles during the electrorefining process 202. For example, in some embodiments, the electrolyte solution 215 may include sodium lauryl sulfate.

In certain embodiments, the cell 205 and/or the electrical source 275 is operated at a voltage lower than 2 volts (V), as it has been found that in certain exemplary embodiments this operating parameter facilitates hydrogen production during the electrorefining process 202. In certain embodiments, the cathode 220 in the electrorefining cell 205 may comprise copper (Cu), nickel (Ni), or alloys thereof. In certain embodiments of the electrorefining process, the purified metal deposited or electroplated at the cathode 220 may be characterized by a purity of less than 99%, or less than 98%, or less than 97%, or less than 95%.

The present disclosure also provides an electrorefining system 200 for generating hydrogen during an electrorefining process 202. The electrorefining system 200 may include an electrorefining cell 205 that includes one or more anodes 210 and one or more cathodes 220 and that is operable to contain and generate an electrorefining process 202 therein so as to deposit a purified metal 225 at one or more cathodes 220 in the electrorefining cell 205. The electrorefining system 200 may also include an electrolyte solution 215 comprising the metal to be purified positioned in the electrorefining cell 205 to be in contact with the one or more anodes 210 and the one or more cathodes 220. The electrorefining system 200 may also include an electrical source 275 electrically coupled to the one or more anodes 210 and cathodes 220 such that when the electrical source 275 is operated under electrical potential, the purified metal 225 is deposited at the one or more cathodes 220 from the solution 215 and hydrogen gas is generated. The electrorefining system 200 may also include a hydrogen gas collection unit 250 operable to capture and store hydrogen gas produced by the electrorefining cell 205. The electrorefining cell 205 in the system 200 is operable to operate under one or more operating parameters selected to increase hydrogen gas generation during the electrorefining process 202, as described above.

In certain embodiments, the electrorefining system 200 may further include a control system 290 coupled with the cell 205 and electrical source 275. The control system 290 may be operable to control the one or more operating parameters of the cell 205 and/or the electrical source 275 so as to control or affect the amount of hydrogen gas produced during the electrorefining process 202. For example, the control system 290 may be configured to control the chemical composition of the electrolyte solution 215, the voltage of the cell 205, the current density (A/m²) of the cell 205, the voltage difference between the anode 210 and cathode 220 in the cell 205, the residence time of the electrolyte solution 215 in the cell 205, the concentration of metal to be purified in the electrolyte solution 215, the concentration of hydrogen-bearing species in the electrolyte solution 215, and any combination thereof. In certain embodiments, the control system 290 may be configured to control the composition of the electrolyte solution 215 such that it comprises less than or equal to 1 gram (g) dissolved metal to be purified per liter (L) of electrolyte solution 215. In certain embodiments, the control system 290 may be configured to control the composition of the electrolyte solution 215 such that it comprises less than or equal to 1000 ppm dissolved metal to be purified. In certain embodiments, the control system 290 may be configured to operate the cell 205 and/or the electrical source 275 at a voltage lower than 2 volts (V).

In certain embodiments, the presently disclosed electrorefining system 200 and/or the electrorefining cell 205 does not include a hydrogen generation mitigation apparatus that may be otherwise includes in an electrorefining system for the mitigation of risks or product quality resulting from the evolution of hydrogen gas during the electrorefining process. For example, the presently disclosed electrorefining system 200 and/or electrorefining cell 205 may, in certain embodiments, exclude one or more of separate anode and cathode compartments, a barrier separating the anode and the cathode, a diaphragm positioned between the anode and the cathode, an anode bag disposed about the anode, and a cathode bag disposed about the cathode.

According to certain aspects of the present disclosure, electrorefining system 200 may include a hydrogen sensor 240 operable to measure the amount of hydrogen gas evolving from or being produced by cell 205. In at least some instances, hydrogen sensor 240 may be operable to measure the concentration of hydrogen gas collected in the headspace or gas-filled volume of the cell 205 above the electrolyte solution 215. Hydrogen sensor 240 may comprise any equipment capable of ascertaining or measuring hydrogen gas production by cell 205, whether the measurement be a quantitative or qualitative determination of hydrogen gas quantity or concentration.

The hydrogen sensor 240 may be located within cell 205 or external to cell 205. For example, in some instances, the hydrogen sensor 240 may be positioned within cell 205, either in the headspace or gaseous volume above the electrolyte solution 215 or within the electrolyte solution 215 itself. In other instances, the hydrogen sensor 240 may be positioned outside or external to the cell 205. For example, as shown in FIG. 2, hydrogen sensor 240 may be located external to cell 205 and coupled to the cell 205 by a conduit 241 operable to receive gas from the cell 205. For example, as shown in FIG. 2, at least some embodiments may include hydrogen sensor 240 coupled with a conduit 241 in fluid communication with the headspace or gaseous volume above the electrolyte solution 215. For example, hydrogen sensor 240 may be coupled with conduit 241 connecting the hydrogen sensor 240 to cell 205, particularly the headspace above the electrolyte solution 215 where the hydrogen gas may collect after evolving from electrolyte solution 215. In other instances, hydrogen sensor 240 may be coupled to the cell 205 via conduit 241 such that the hydrogen sensor 240 may be in fluid communication with the electrolyte solution 215 or aliquots removed therefrom. In at least some instances, the hydrogen sensor 240 may be operable to measure the concentration or amount of hydrogen gas entering hydrogen gas collection unit 250. In such instances, the hydrogen sensor 240 may be coupled with a conduit 251 connecting the hydrogen gas collection unit 250 to cell 205.

Hydrogen sensor 240 may be in communication with or otherwise electronically coupled to control system 290. In particular, control system 290 may be operable to receive hydrogen gas measurements from hydrogen gas sensor 240 and thus monitor the amount of hydrogen gas generated or produced by cell 205 and/or collected by hydrogen gas collection unit 250. In at least some instances, hydrogen gas collection unit 250, or a component thereof, may be electronically coupled with control system 290. Control system 290 may be configured to adjust one or more operating parameters of the cell 205 and/or the electrical source 275 based on the measurement(s) received from the hydrogen sensor 240. In at least some instances, the control system 290 may be configured or otherwise operable to increase or decrease the hydrogen generation of the cell 205 by adjusting one or more operating parameters of the cell 205 in response to hydrogen gas measurements received by the control system 290 from the hydrogen sensor 240. In at least some instances, the hydrogen sensor 240, and measurements provided therefrom, as well as the control system 290 configured to adjust one or more operating parameters of the cell 205 based on the hydrogen measurements received from the hydrogen sensor 240, form or create a feedback loop responsive to hydrogen gas generation by the cell 205.

In at least some instances, the control system 290 may be configured to maintain the hydrogen gas production rate of the cell 205 within a predetermined range of desirable and safe hydrogen gas production rates. Similarly, control system 290 may be configured to maintain the amount or concentration of hydrogen gas in one or more portions of system 200 or cell 205 within a predetermined amount or concentration, or predetermined range of amounts or concentrations, by adjusting one or more operating parameters of the cell 205 based on feedback from the hydrogen sensor 240. The one or more operating parameters of the cell 205 that may be adjusted by control system 290 based on feedback measurements obtained from hydrogen sensor 240, may include, for example, the chemical composition of the electrolyte solution 215, the voltage of the cell 205, the current density (A/m²) of the cell 205, the voltage difference between the anode 210 and cathode 220 in the cell 205, the residence time of the electrolyte solution 215 in the cell 105, the concentration of metal to be purified in the electrolyte solution 215, the concentration of hydrogen-bearing species in the electrolyte solution 215, and any combination thereof. Control system 290 may adjust or control the voltage of the cell 205, the current density (A/m²) of the cell 205, and the voltage difference between the anode 210 and cathode 220 in the cell 205 by operating or controlling electrical source 275, which is electronically coupled with control system 290.

Control system 290 may adjust or control the chemical composition of the electrolyte solution 215, the residence time of the electrolyte solution 215 in the cell 205, the concentration of metal to be purified in the electrolyte solution 215, and the concentration of hydrogen-bearing species in the electrolyte solution 215 by operating or controlling solution chemistry adjuster apparatus 236 and/or pump 238. As shown in FIG. 2, solution chemistry adjuster apparatus 236 may be coupled with cell 205 via conduit 235 which is configured to allow the passage of new electrolyte solution 215, additional solution components, and/or the removal of spent electrolyte solution 215 from cell 205. As shown in FIG. 2, pump 238 may be fluidly coupled with solution chemistry adjuster apparatus 236 and cell 205 via conduit 235. In at least some instances, solution chemistry adjuster apparatus 236 may be operable to add additional hydrogen-bearing species or other chemical components to the electrolyte solution 215, or alter the residence time of the electrolyte solution 215 in cell 205 by flowing additional electrolyte solution 215 into the cell 205 or removing spent electrolyte solution 215 from the cell 205.

Control system 290 may also be communicatively coupled with one or more pH sensors 232 as well as other solution chemistry sensors 234 operable to measure the pH of the electrolyte solution 215 or other chemical parameters and communicate such measurements to the control system 290. The control system 290 may operate the solution chemistry adjuster apparatus 236 based on feedback and measurements provided by pH sensor 232 and/or solution chemistry sensor 234. pH sensor 232 may be positioned in contact with electrolyte solution 215, either within cell 205 or exterior to cell 205. When pH sensor 232 is positioned outside of cell 205, the pH sensor 232 may be in fluid communication with the electrolyte solution 215 via conduit 231. Similarly, solution chemistry sensor 234 may be positioned in contact with electrolyte solution 215, either within cell 205 or exterior to cell 205. When the solution chemistry sensor 234 is positioned outside of cell 205, the solution chemistry sensor 234 may be in fluid communication with the electrolyte solution 215 via conduit 233.

In at least some instances, control system 290 may be configured to maintain the pH of the electrolyte solution 215 within a predetermined range by controlling or operating the solution chemistry adjuster apparatus 236 to introduce chemical components to adjust the pH of the electrolyte solution 215 in order to obtain or maintain the pH of the electrolyte solution 215 within the predetermined range. In at least some instances, the predetermined range of pH is between about 10 and 11.

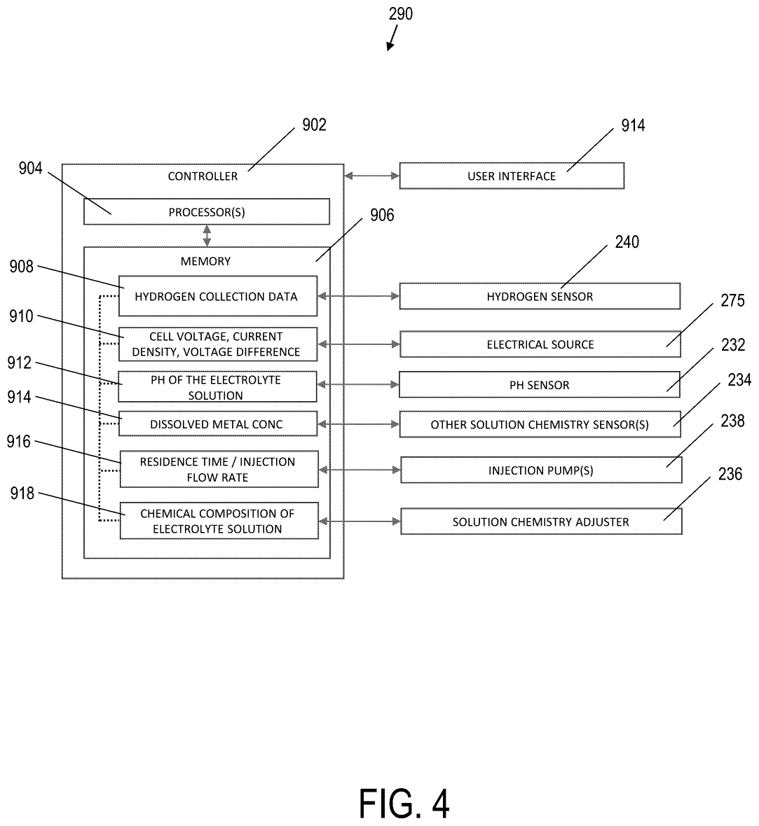

FIG. 4 depicts a graphical representation of a control system 290 for controlling the generation of hydrogen in a cell during an electrodeposition process, in particular electrorefining process, according to an exemplary embodiment of the present disclosure. Other embodiments of control systems 290 are within the spirit and scope of the present disclosure. As depicted in FIG. 4, control system 290 may include a controller 902. Controller 902 may comprise one or more controllers, a programmable logic controller (PLC), a supervisory control and data acquisition (SCADA) system, a computing device, and combinations thereof, as well as other components, to manage or control the generation of hydrogen in cell 105, particularly to control the generation of hydrogen gas in cell 105 such that hydrogen gas is generated at a production rate that is within a predetermined range determined to be safe and economically advantageous. Controller 902 may include one or more processors (e.g., processor 904) to execute instructions stored in memory 906. In an exemplary embodiment, the memory 906 may be a machine-readable storage medium. As used herein, a “machine-readable storage medium” may be any electronic, magnetic, optical, or other physical storage apparatus to contain or store information such as executable instructions, data, and the like. For example, any machine-readable storage medium describe herein may be any of random access memory (RAM), volatile memory, non-volatile memory, flash memory, a storage drive (e.g., hard drive), a solid state drive, any type of storage disc, and the like, or a combination thereof. As noted, the memory 906 may store or include instructions executable by processor 904. As used herein, a “processor” may include, for example one processor or multiple processors included in a single device or distributed across multiple computing devices. The processor 904 may be at least one of a central processing unit (CPU), a semiconductor-based microprocessor, a graphics processing unit (GPU), a field-programmable gate array (FPGA) to retrieve and execute instructions, a real time processor (RTP), other electronic circuitry suitable for the retrieval and execution of instructions stored on a machine-readable storage medium, or a combination thereof.

Instructions stored in the memory 906 and executable by the processor 904 may include instructions 910 to determine, control, or adjust the cell voltage, current density, or voltage difference in the cell by controlling electrical source 275. Controller 902 may control the electrical source 275 in order to adjust the cell voltage, current density, or voltage difference between the cathode 220 and electrode 210 in the cell 205. Controller 902 may also include instructions 908 for determining hydrogen collection data, particularly the hydrogen gas generation rate of the cell, using hydrogen sensor 240. Controller 902 may also include instructions 912 for determining the pH of the electrolyte solution by operating pH sensor 232. Similarly, controller 902 may include instructions 914 for determining the dissolved metal concentration in the electrolyte solution through operation of solution chemistry sensor(s) 234. Controller 902 may further include instructions 916 for controlling the residence time and injection flow rate of the electrolyte solution in the cell as well as instructions 918 for controlling the chemical composition of the electrolyte solution by operating injection pump(s) 238 and solution chemistry adjuster 236. Instructions or data may also be received from user interface 914 and generally stored in memory 906.

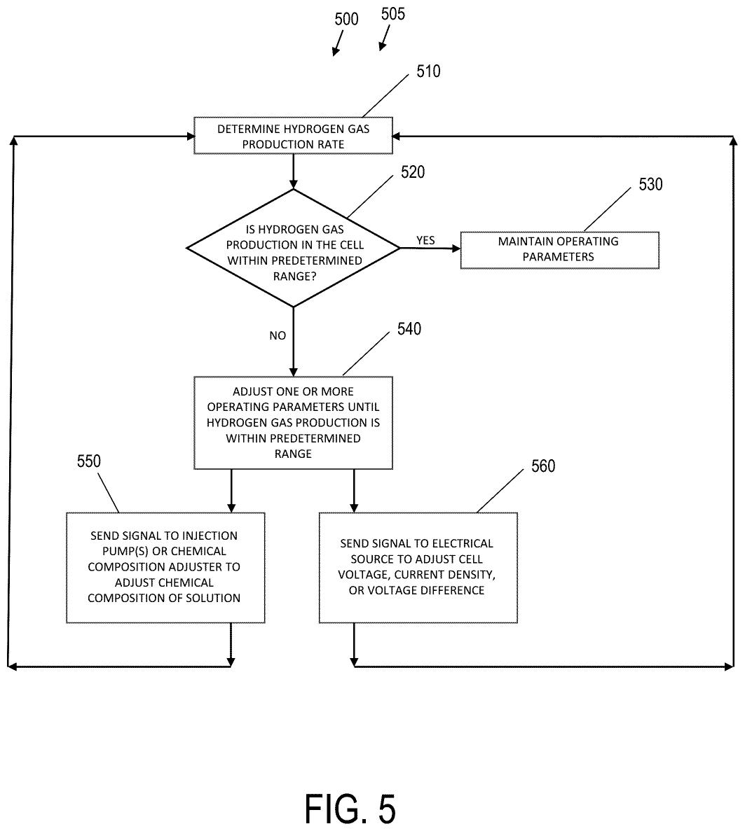

FIG. 5 is a flow diagram that may be implemented by a control system, such as control systems 190, 290 shown in FIG. 3 or FIG. 4, of a method 500 and system 505 for controlling the hydrogen gas production rate in a cell during an electrowinning process or during an electrorefining process, according to an exemplary embodiment of the present disclosure. As depicted in FIG. 5, method 500 and system 505 may include determining the hydrogen gas production rate at block 510. The hydrogen gas production rate may be determined, for example, by hydrogen gas sensor 140, 240 in systems 100, 200. Method 500 and system 505 may then determine at block 520 whether hydrogen gas production in the cell is within a predetermined range determined to be safe and economically advantageous, based on the hydrogen gas production rate determined at block 510. For example, the determination at block 520 may be determined by controller 902 in control systems 190, 290 shown in FIG. 3 or 4. If at block 520 hydrogen gas production in the cell is determined to be within the predetermined range, the operating parameters of the cell are maintained at block 530.

If at block 520, hydrogen gas production in the cell is determined to not be within the predetermined range, one or more operating parameters of the cell are adjusted at block 540 until hydrogen gas production is measured to be within the predetermined range at blocks 510 and 520. In particular, at block 550, controller 906 may send a signal to injection pump(s) 138, 238 and/or solution chemistry adjuster 136, 236 so as to adjust one or more chemical operating parameters in the cell, such as the dissolved metal concentration, residence time of the solution in the cell, injection flow rate of the solution in the cell, or the chemical composition of the solution in the cell in order to adjust the hydrogen gas production rate so that it is within the desired predetermined range. Controller 906 may also at block 560 send a signal to the electrical source 175, 275 so as to adjust the cell voltage, current density, or voltage difference between the cathode and electrode in order to adjust the hydrogen gas production rate so that it is within the desired predetermined range.

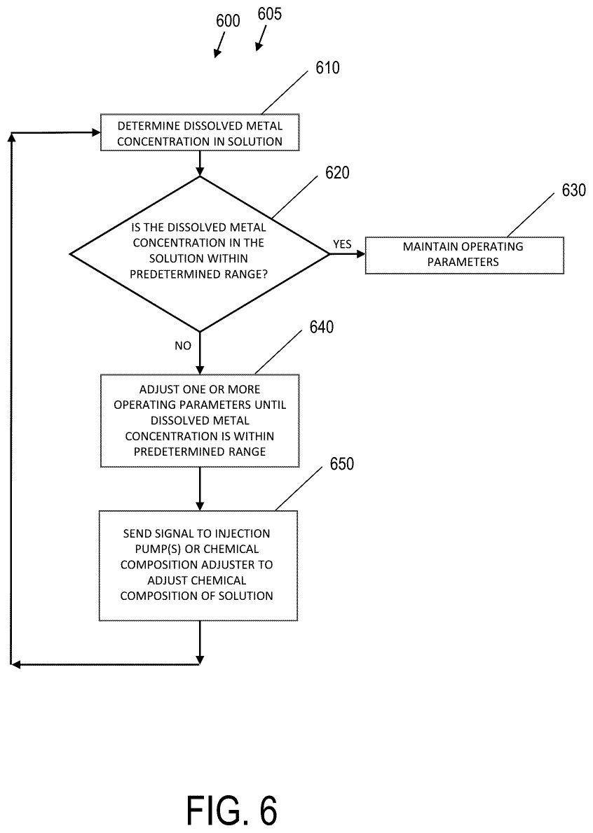

FIG. 6 is a flow diagram that may be implemented by a control system, such as the control system 190, 290 shown in FIG. 3 or FIG. 4, of a method 600 and system 605 for controlling the dissolved metal concentration in a cell during an electrodeposition process, such as an electrowinning process or an electrorefining process, according to an exemplary embodiment of the present disclosure. As depicted in FIG. 6, method 600 and system 605 may include determining the dissolved metal concentration at block 610. The dissolved metal concentration may be determined, for example, by solution chemistry sensors 134, 234 in systems 100, 200. Method 600 and system 605 may then determine at block 620 whether the dissolved metal concentration in the cell is within a predetermined range determined to be beneficial to the economic generation of hydrogen gas in the cell, based on the dissolved metal concentration determined at block 610. For example, the determination at block 620 may be determined by controller 902 in control systems 190, 290 shown in FIG. 3 or 4. If at block 620 the dissolved metal concentration in the cell is determined to be within the predetermined range, the operating parameters of the cell are maintained at block 630.

If at block 620, the dissolved metal concentration in the cell is determined to not be within the predetermined range, one or more operating parameters of the cell are adjusted at block 640 until the dissolved metal concentration is measured to be within the predetermined range at blocks 610 and 620. In particular, at block 650, controller 906 may send a signal to injection pump(s) 138, 238 and/or solution chemistry adjuster 136, 236 so as to adjust one or more chemical operating parameters in the cell, such as the dissolved metal concentration, residence time of the solution in the cell, injection flow rate of the solution in the cell, or the chemical composition of the solution in the cell in order to adjust the dissolved metal concentration in the cell so that it is within the desired predetermined range.

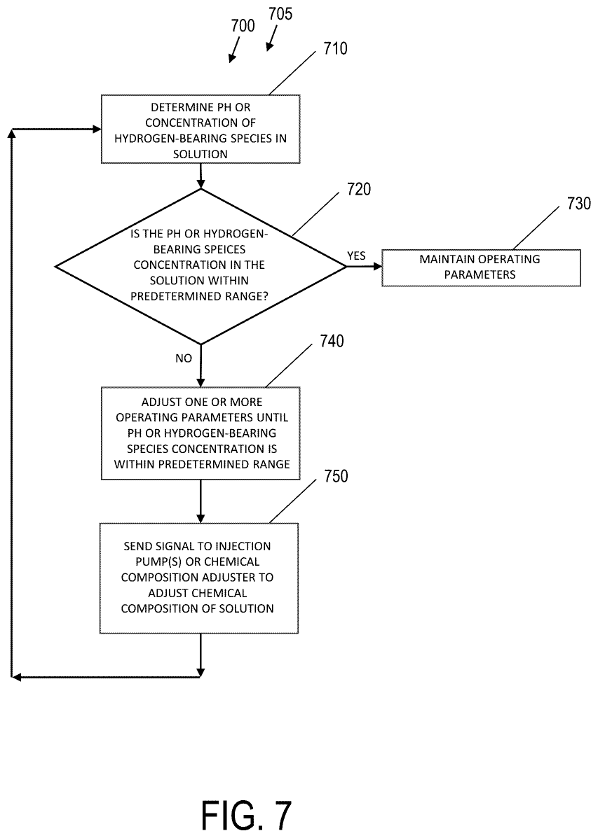

FIG. 7 is a flow diagram that may be implemented by a control system, such as control systems 190, 290 shown in FIG. 3 or FIG. 4, of a method 700 and system 705 for controlling the pH or the hydrogen-bearing species concentration in a cell during an electrodeposition process, such as an electrowinning process or an electrorefining process, according to an exemplary embodiment of the present disclosure. As depicted in FIG. 7, method 700 and system 705 may include determining the pH or concentration of hydrogen-bearing species in the solution at block 710. The pH or concentration of hydrogen-bearing species in the solution may be determined, for example, by pH sensor 132, 232 or solution chemistry sensors 134, 234 in systems 100, 200. Method 700 and system 705 may then determine at block 720 whether the pH or hydrogen-bearing species concentration of the solution in the cell is within a predetermined range determined to be beneficial to the economic generation of hydrogen gas in the cell, based on the determination at block 710. For example, the determination at block 720 may be determined by controller 902 in control systems 190, 290 shown in FIG. 3 or 4. If at block 720 the pH or the hydrogen-bearing species concentration in the solution in the cell is determined to be within the predetermined range, the operating parameters of the cell are maintained at block 730.

If at block 720, the pH or the concentration of hydrogen-bearing species in the cell is determined to not be within the predetermined range, one or more operating parameters of the cell are adjusted at block 740 until the pH or the concentration of hydrogen-bearing species is measured to be within the predetermined range at blocks 710 and 720. In particular, at block 750, controller 906 may send a signal to injection pump(s) 138, 238 and/or solution chemistry adjuster 136, 236 so as to adjust one or more chemical operating parameters in the cell, such as the dissolved metal concentration, residence time of the solution in the cell, injection flow rate of the solution in the cell, or the chemical composition of the solution in the cell in order to adjust the pH or the concentration of hydrogen-bearing species in the solution in the cell so that it is within the desired predetermined range.

When ranges are disclosed herein, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, reference to values stated in ranges includes each and every value within that range, even though not explicitly recited. Thus, every point or individual value may serve as its own lower or upper limit combined with any other point or individual value or any other lower or upper limit, to recite a range not explicitly recited.

This application claims priority to, and the benefit of U.S. Provisional Application No. 63/385,914, filed Dec. 2, 2022, titled “RENEWABLE HYDROGEN PRODUCTION FROM THE PURIFICATION OF RAW METALS,” the disclosure of which is incorporated herein by reference in its entirety.

Other objects, features and advantages of the disclosure will become apparent from the foregoing figures, detailed description, and examples. It should be understood, however, that the figures, detailed description, and examples, while indicating specific embodiments of the disclosure, are given by way of illustration only and are not meant to be limiting. In further embodiments, features from specific embodiments may be combined with features from other embodiments. For example, features from one embodiment may be combined with features from any of the other embodiments. In further embodiments, additional features may be added to the specific embodiments described herein.

What is claimed is:

1. A method of generating hydrogen during an electrodeposition process, the method comprising:
causing an electrodeposition process in an electrodeposition cell so as to deposit a purified metal at a cathode of the cell, the cell comprising:
one or more anodes;
one or more cathodes;
an electrolyte or leaching solution comprising the metal to be purified, the solution positioned in the cell to be in contact with the one or more anodes and the one or more cathodes; and
an electrical source electrically coupled to the one or more anodes and cathodes such that when the electrical source is operated under electrical potential, the purified metal is deposited at the one or more cathodes from the solution and hydrogen gas is generated; and
operating the cell under one or more operating parameters selected to increase hydrogen gas generation during the electrodeposition process.

2. The method of claim 1, wherein the one or more operating parameters selected to increase hydrogen gas production comprise one or more of a chemical composition of the solution, a voltage of the cell, a current density (A/m²) of the cell, a voltage difference between the anode and cathode in the cell, a residence time of the solution in the cell, a concentration of metal to be purified in the solution, or the concentration of hydrogen-bearing species in the solution.

3. The method of claim 1, wherein the solution comprises one of (a) less than or equal to 1 gram (g) dissolved metal to be purified per liter (L) of solution, (b) less than or equal to 1000 ppm dissolved metal to be purified, (c) less than or equal to 1000 ppm dissolved copper (Cu) or less than or equal to 1 gram (g) dissolved copper (Cu) per liter (L) of solution, (d) sodium lauryl sulfate at a concentration sufficient to liberate H₂ gas bubbles from a surface of the cathode, (e) a copper sulfate-sulfuric acid (CuSO₄—H₂SO₄) electrolyte solution, (f) a nickel chloride electrolyte solution.

4. The method of claim 1, further comprising:
obtaining a hydrogen gas stream generated by the cell;
removing water from the hydrogen gas stream to generate a purified hydrogen gas stream; and
collecting the purified hydrogen gas stream.

5. The method of claim 1, wherein the cell and/or the electrical source is operated at a voltage lower than 2 volts (V).

6. The method of claim 1, wherein the solution comprises one or more chemical compounds having at least one hydrogen atom, and wherein the one or more chemical compounds having at least one hydrogen atom comprises one or more of sulfuric acid (H₂SO₄), potassium hydroxide (KOH), or sodium hydroxide (NaOH).

7. The method of claim 1, wherein one or more of (a) the solution comprises a pH less than 3 or (b) the cell is operated such that the pH of the solution proximal to the cathode is less than 3.

8. The method of claim 1, wherein the purified metal comprises one or more of copper (Cu), nickel (Ni), or cobalt (Co), wherein the one or more cathodes comprise one or more of stainless steel, aluminum (Al), titanium (Ti), a titanium wire or mesh, copper (Cu), nickel (Ni), or alloys thereof, and wherein the one or more anodes are comprised of lead (Pb) or a lead-alloy.

9. A system for generating hydrogen during an electrodeposition process, the system comprising:
an electrodeposition cell operable to contain and generate an electrorefining or electrowinning process therein so as to deposit a purified metal at a cathode of the cell, the cell comprising one or more anodes and one or more cathodes;
a solution comprising the metal to be purified, the solution positioned in the cell to be in contact with the one or more anodes and the one or more cathodes;
an electrical source electrically coupled to the one or more anodes and cathodes such that when the electrical source is operated under electrical potential, the purified metal is deposited at the one or more cathodes from the solution and hydrogen gas is generated; and
a hydrogen gas collection unit operable to capture and store hydrogen gas produced by the cell, the cell operable to operate under one or more operating parameters selected to increase hydrogen gas generation during the electrodeposition process.

10. The system of claim 9, further comprising a controller coupled with the cell and the electrical source, the controller operable to control the one or more operating parameters so as to control an amount of hydrogen gas produced during the electrodeposition process.

11. The system of claim 9, wherein the one or more operating parameters selected to increase hydrogen gas production comprise one or more of a chemical composition of the solution, a voltage of the cell, a current density (A/m²) of the cell, a voltage difference between the anode and cathode in the cell, a residence time of the solution in the cell, a concentration of metal to be purified in the solution, or a concentration of hydrogen-bearing species in the solution.

12. The system of claim 9, wherein the hydrogen gas collection unit operable to capture and store the hydrogen gas (H₂) from the cell for use as a fuel or as a reagent in a chemical process, the hydrogen gas collection unit comprising:
a water absorption unit configured to receive a hydrogen gas stream generated by the cell and remove water from the hydrogen gas stream to produce a purified hydrogen gas stream;
a housing defining a receiving space operate to receive and store the purified hydrogen gas stream; and
a compressor operable to compress the purified hydrogen gas received in the receiving space so as to increase an amount of purified hydrogen gas able to be stored therein.

13. The system of claim 9 wherein the cathode comprises an interior cavity configured to receive hydrogen gas generated by the cell and conduct the received hydrogen gas to the hydrogen collection unit or a conduit coupled with the hydrogen collection unit.

14. The system of claim 9, wherein the solution comprises one or more chemical compounds having at least one hydrogen atom, and wherein the one or more chemical compounds having at least one hydrogen atom comprise one or more of sulfuric acid (H₂SO₄), potassium hydroxide (KOH), or sodium hydroxide (NaOH).

15. The system of claim 9, wherein the solution comprises a leaching solution operable to leach the metal to be purified from an impure composition, the metal to be purified derived from the impure composition.

16. The system of claim 9, wherein the solution is an electrolyte solution including the metal to be purified, the metal to be purified derived from an impure composition positioned at the anode or forming the anode.

17. The system of claim 9, wherein the cell is operated at suboptimal conditions for purification of the metal to be purified.

18. The system of claim 9, wherein the purified metal deposited at the cathode is characterized by a purity of less than 99%, 98%, 97%, 96%, or 95%.

19. A controller to manage generation hydrogen during an electrodeposition process, the controller comprising:
a processor and a machine-readable storage medium, the machine readable storage medium to store instructions to, when executed by the processor:
obtain one or more operating parameters from one or more sensors or equipment associated with an electrodeposition unit, the electrodeposition unit including:
an electrodeposition cell comprising one or more anodes and one or more cathodes and operable to perform an electrodeposition process therein thereby depositing a purified metal at the one or more cathodes,
a solution including the metal to be purified, the solution positioned in the cell to be in contact with the one or more anodes and the one or more cathodes,
an electrical source coupled to the one or more anodes and the one or more cathodes and to cause deposition of the purified metal to at the one or more cathodes and generation of hydrogen gas, and
a hydrogen gas collection unit to capture and store hydrogen gas produced by the cell under one or more operating parameters selected to increase hydrogen gas generation during the electrodeposition process;
determine whether a hydrogen gas production rate is within a predetermined range based on the one or more operating parameters; and
adjust the one or more operating parameters until the hydrogen gas production rate in the cell is within the predetermined range.

20. The controller of claim 19, wherein the one or more operating parameters comprise one or more of the chemical composition of the solution, the voltage of the cell, the current density (A/m²) of the cell, the voltage difference between the anode and cathode in the cell, the residence time of the solution in the cell, the concentration of metal to be purified in the solution, or the concentration of hydrogen-bearing species in the solution.
